(19) United States
(12) Patent Application Publication
(10) Pub. No.: US 2020/0156524 A1
(43) Pub. Date: May 21, 2020

(54) VEHICLE FLOOR MAT

(71) Applicant: GM GLOBAL TECHNOLOGY OPERATIONS LLC, Detroit, MI (US)

(72) Inventors: Josue Rey Castillo Grana, Ecatepec de Morelos (MX); Alejandro Hernandez Covarrubias, Metepec (MX)

(21) Appl. No.: 16/192,966

(22) Filed: Nov. 16, 2018

(51) Int. Cl. B60N 3/04

(52) U.S. Cl. CPC B60N 3/044; B60N 3/042

(57) ABSTRACT

A floor mat for a vehicle includes a first flap section, a second flap section and a hinge connecting corresponding ends of each of the first flap section and the second flap section.

### FIELD

The present disclosure relates to a vehicle floor mat.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Vehicle passenger compartments may be equipped with floor trays or mats that fit into the foot wells and serve to protect underlying flooring, e.g., carpeting from exposure to liquids, dirt, debris and other elements that are tracked into the vehicle by passengers. These mats also serve to protect the underlying flooring from the wear that would otherwise adversely affect the condition of the flooring due to potentially abrading contact with passengers.

### SUMMARY

In an exemplary aspect, a floor mat for a vehicle includes a first flap section, a second flap section, and a hinge connecting corresponding ends of each of the first flap section and the second flap section.

In this manner, a single vehicle floor mat may be reconfigured to provide varying passenger facing surfaces to the passenger.

In another exemplary aspect, a first passenger facing surface of the first flap section has a different texture than a second passenger facing surface of the second flap section.

In another exemplary aspect, the first passenger facing surface includes a carpeted surface.

In another exemplary aspect, the second passenger facing surface includes a rubberized surface.

In another exemplary aspect, the shape of an outer peripheral edge of each of the first flap section and the second flap section corresponds to a vehicle passenger footwell shape.

In another exemplary aspect, the hinge includes a living hinge.

In another exemplary aspect, the living hinge includes a textile hinge.

In another exemplary aspect, the living hinge includes a rubberized hinge material.

In another exemplary aspect, further includes a flexible molded frame configured to receive corresponding ends of each of the first flap section and the second flap section such that they are aligned and entirely overlap each other.

In another exemplary aspect, the flexible molded frame includes a u-shaped portion that receives the corresponding ends of each of the first flap section and the second flap section therein.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view of an exemplary vehicle floor mat in accordance with the present disclosure in an intermediate configuration;

FIG. 2 is a perspective view of the floor mat of FIG. 1 in a first usable configuration;

FIG. 3 is a partial cross-section view of the vehicle floor mat of FIG. 2 at the living hinge taken along line A-A; and

FIG. 4 is a partial cross-section view of the vehicle floor mat taken along line B-B in FIG. 2.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

The inventors of the present disclosure understand that conventional vehicle floor mats are limited in that they only offer a single type of surface to the passenger. This is undesirable as a passenger may prefer to have a vehicle mat with a carpeted surface which may be more comfortable and a vehicle floor mat with a more rugged surface which is easier to clean and dry. In order to satisfy these varying requirements with conventional vehicle floor mats a passenger is required to fully replace the vehicle floor mat whenever a change of surface is desired. This requires possession of multiple styles of vehicle floor mats each of which adds to the cost and also requires the passenger to have a storage location readily available for those vehicle floor mats which the passenger is not currently using. The inventors realized that it would be desirable to provide a vehicle floor mat which has the capability of providing a variety of surfaces to the passenger.

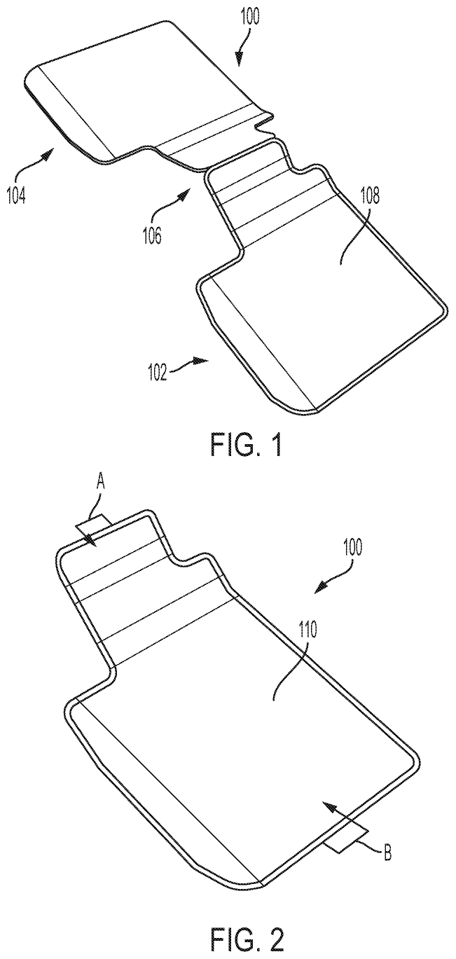

Referring now to the drawings, wherein like reference numbers correspond to like or similar components throughout the several figures, FIG. 1 and FIG. 2 provide perspective views of an exemplary vehicle floor mat 100 in accordance with the present disclosure. The vehicle floor mat 100 includes a first flap section 102 and a second flap section 104 that are connected by a living hinge 106. Each of the first flap section 102 and second flap section 104 include a passenger facing surface which each present a different type of surface to the passenger. A first passenger facing surface 108 corresponds to a top surface of the first flap section 102 in FIG. 1 and a second passenger facing surface 110 corresponds to a top surface of the second flap section 104. FIG. 1 illustrates the vehicle floor mat 100 in an intermediate configuration where the first flap section 102 and the second flap section 104 have been hinged away from each other via the living hinge 106 while FIG. 2 illustrates the vehicle floor mat 100 in a first usable configuration where the vehicle floor mat 100 presents the second passenger facing surface 110 to the passenger and the second flap section 104 overlays the first flap section 102 thereby concealing the first passenger facing surface 108 from the passenger. Alternatively, the vehicle floor mat 100 may be configured in a second usable configuration where the vehicle floor mat 100 presents the first passenger facing surface 108 to the passenger and the first flap section 102 overlays the second flap section 104 thereby concealing the second passenger facing surface 110 from the passenger. In this manner, the inventive vehicle floor mat of the present disclosure provides the ability to present multiple passenger facing surfaces to a passenger thereby enabling the passenger to choose between passenger facing surfaces merely by re-configuring the vehicle floor mat by hinging the first flap section 102 and the second flap section 104 relative to each other.

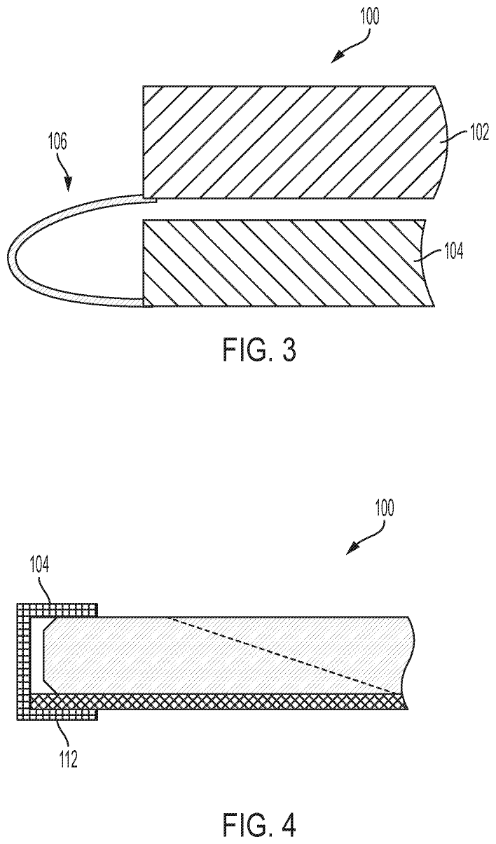

FIG. 3 is a partial cross-section view of the vehicle floor mat 100 at the living hinge 106 taken along line A-A in FIG. 2. The living hinge 106 is formed from a flexible material that connects corresponding ends of the first flap section 102 and the second flap section 104. In one exemplary aspect, the living hinge 106 may be formed from a rubberized material which may also form an underlying structural portion (not illustrated) of the first flap section 102 and the second flap section 104. Alternatively, the living hinge 106 may be formed of a textile material.

FIG. 4 is a partial cross-section view of the vehicle floor mat 100 taken along line B-B in FIG. 2. The vehicle floor mat 100 includes an optional flexible molded frame 112 that forms a u-shaped portion 114 which receives and holds the corresponding ends of each of the first flap section 102 and second flap section 104 in alignment with each other.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A floor mat for a vehicle, the mat comprising:
a first flap section;
a second flap section; and
a hinge connecting corresponding ends of each of the first flap section and the second flap section.

2. The mat of claim 1, wherein a first passenger facing surface of the first flap section has a different texture than a second passenger facing surface of the second flap section.

3. The mat of claim 2, wherein the first passenger facing surface comprises a carpeted surface.

4. The mat of claim 2, wherein the second passenger facing surface comprises a rubberized surface.

5. The mat of claim 1, wherein the shape of an outer peripheral edge of each of the first flap section and the second flap section corresponds to a vehicle passenger footwell shape.

6. The mat of claim 1, wherein the hinge comprises a living hinge.

7. The mat of claim 6, wherein the living hinge comprises a textile hinge.

8. The mat of claim 6, wherein the living hinge comprises a rubberized hinge material.

9. The mat of claim 1, further comprising a flexible molded frame configured to receive corresponding ends of each of the first flap section and the second flap section such that they are aligned and entirely overlap each other.

10. The mat of claim 9, wherein the flexible molded frame comprises a u-shaped portion that receives the corresponding ends of each of the first flap section and the second flap section therein.
